(19) United States
(12) Patent Application Publication
(10) Pub. No.: US 2026/0210543 A1
(43) Pub. Date: Jul. 23, 2026

(54) Method for Controlling a Steam Network and Steam Network

(71) Applicant: Covestro Deutschland AG, Leverkusen (DE)

(72) Inventors: Franz Kirchhoff, Pulheim (DE); Sebastian Telgen, Korschenbroich (DE)

(21) Appl. No.: 19/138,750

(22) PCT Filed: Dec. 13, 2023
(86) PCT No.: PCT/EP2023/085465

§ 371 Date: Jun. 13, 2025

(30) Foreign Application Priority Data
Dec. 16, 2022 (EP) 22214319.0

(51) Int. Cl. F22B 35/18; G05D 7/06

(52) U.S. Cl. CPC F22B 35/18; G05D 7/0688

(57) ABSTRACT

The disclosure relates to a method for controlling a steam network. The steam network includes sub-networks wherein each sub-network is connected with an external steam generating source that provides the sub-network with steam at internal steam pressure, where the internal steam pressure is different for each sub-network. The steam network includes steam consumers, each steam consumer supplied with steam by a sub-network, the steam network including at least one inter-network valve for interconnecting a respective pair of the plurality of sub-networks, the method including a) measuring steam consumption data of each sub-network b) predicting a future steam consumption rate of each sub-network based on the measured steam consumption data of each sub-network and c) controlling the at least one inter-network valve for providing steam from a sub-network with higher internal steam pressure to a sub-network with lower internal steam pressure based on the predicted future steam consumption rates.

### CROSS-REFERENCE TO RELATED APPLICATIONS

This application is the United States national phase of International Patent Application No. PCT/EP 2023/085465 filed Dec. 13, 2023, and claims priority to European Patent Application No. 22214319.0 filed Dec. 16, 2022, the disclosures of which are hereby incorporated by reference in their entireties.

### BACKGROUND

### Technical Field

The invention is directed at a method for controlling a steam network. The invention is also directed at a steam network.

### Description of Related Art

There are a wide variety of processes in any chemical plant for which steam is used. This holds true across the spectrum of a large number of kinds of chemical plants, which in turn is itself also very wide. For example, steam is used for saturating process streams, for reforming reactions and also for driving turbines to generate electrical power. In general, once steam is used for a particular process, it cannot be used again for a different process and is therefore consumed by its use. Depending on the particular use to which the steam is put, it may be required to have that steam at a certain minimum pressure. Thus, the demand for steam of a particular process is not only defined by the total energy of the steam provided to that process, but also by the pressure that the steam needs to have to be useful.

Just as there are usually different processes within a plant that consume steam as described above, there are also often different sources of steam either within a chemical plant or provided to the chemical plant. These sources regularly differ both in the pressure of the steam that they provide as well as in the total amount of steam, for example measured in energy, that they can provide. This can also mean that the operation of the different sources of steam differs in the associated costs, thereby making high-pressure steam more expensive than low-pressure steam.

### SUMMARY

In light of these circumstances, the object of the present invention is to provide a method for controlling a steam network which enables to more efficiently match steam sources and steam consumers through the steam network. The object of the invention is further to provide a steam network which enables to more efficiently match steam sources and steam consumers through the steam network.

With respect to the method for controlling a steam network, the object of the invention is achieved by a method for controlling a steam network with the features as described herein. With respect to the steam network, the object of the invention is achieved by a steam network with the features as described herein.

### BRIEF DESCRIPTION OF THE DRAWINGS

Further advantageous and preferred features are discussed in the following description with respect to the Figures. In the following it is shown in

FIG. 1 an illustration of an embodiment of the steam network according to the invention for executing an embodiment of the method according to the invention and

FIG. 2 an illustration of a data processing system usable for executing the embodiment of the method according to the invention for the steam network of FIG. 1.

### DETAILED DESCRIPTION

The invention is based on the realization that steam with higher pressure may be used for steam consumers which would normally only require lower pressure. In general, high-pressure steam is scarcer than low-pressure steam, which is why it is generally preferred to use it for processes which do require high-pressure steam. However, in a system with multiple steam sources which differ in pressure and may also differ in maximum capacity of supplying steam, as well as with multiple steam consumers which may have a time-varying steam demand, it may be economical to at times use higher-pressure steam for steam consumers that could also be supplied with lower-pressure steam, even though this is counterintuitive based on the notion that steam is “wasted” by not fully exploiting its higher pressure. Naturally, obtaining lower-pressure steam from higher-pressure steam is easier than the other way around.

The method according to the invention is for controlling a steam network, wherein the steam network comprises a plurality of sub-networks, wherein each sub-network is connected with a respective external steam generating source that provides the respective sub-network with steam at a respective internal steam pressure, wherein the respective internal steam pressure is different for each sub-network. In other words, each sub-network is a system of conduits, pipes etc. for distributing steam that operates at a certain pressure, i.e. the internal steam pressure, which is different for any two sub-networks. The steam generating sources may in principle be any kind of steam generating source. The steam generating sources are external in the sense that their operation is not controlled by the method according to the invention. In other words, the pressure and amount of steam which they provide is provided as-is from the point of view of the steam network according to the invention and the method according to the invention. Nonetheless, the ability of the steam generating sources to provide steam at a certain quantity or rate may vary in time. It may also be that the steam generating sources adjust their steam production rate on their own based on the respective amount of steam taken. It may also be that the external steam generating sources are themselves supplied from a single common source of steam or energy. Here it is only relevant that, from the point of view of the steam network, steam is provided at a plurality of steam pressures, with the source corresponding to each steam pressure presenting a respective external steam generating source in the sense of the invention. Internal to themselves, this plurality of external steam generating sources may be interconnected in an arbitrary way.

It is to be noted that certain methods to optimize the fuel feed to the steam generators are known from the art. For example, US 2004/0093124 A1 discloses a steam generation plant which comprises a plurality of loads in the form of boilers, turbines or chillers. An optimization algorithm implements an optimal dynamic allocation of fuel feed demands for the loads by means of a model-based predictive controller. The predictive controller suitably senses the load requirements (e.g., pressure, and/or fuel feed, and/or temperature, etc.) of the loads, and provides a predicted total load energy demand to a real time optimizer (RTO) that divides the total load energy demand according to a predicted target allocation into individual allocated fuel feed demands (or set points) for the individual loads. This concept which is located on the steam generating sources may be added the concept of the present invention in order to optimize the steam production.

In the method according to the invention, the steam network further comprises a plurality of steam consumers, each steam consumer supplied with steam by a respective sub-network. In other words, each steam consumer, which may in principle be any kind of steam consumer, is provided with steam from a particular sub-network and therefore with steam with a particular internal steam pressure. It may also be that more than one steam consumer is supplied by the same sub-network. In addition, it may also be that some devices or constructions understood to present a steam consumer are supplied by a plurality of sub-networks and therefore with steam of more than one steam pressure. It may also be that such devices or construction internally mix the supplied steam from the different sub-networks, i.e. steam at different pressures. Such a device, construction or other apparatus is then understood to present a plurality of steam consumers in the sense of the invention, i.e. one steam consumer for each steam pressure.

In the method according to the invention, the steam network further comprises at least one inter-network valve for interconnecting a respective pair of the plurality of sub-networks. Thus, steam can be selectively released from one sub-network to another through this valve. In particular, the at least one inter-networking valve is configured to selectively pass steam from a sub-network with higher internal steam pressure to a sub-network with lower internal steam pressure. In particular, the rate of steam released through the valve from one sub-network to another may be controlled. Thus, the inter-network valves need not be binary in their operation.

The method according to the invention comprises a) measuring steam consumption data of each sub-network, b) predicting a future steam consumption rate of each sub-network based on the measured steam consumption data of each sub-network and c) controlling the at least one inter-network valve for providing steam from a sub-network with higher internal steam pressure to a sub-network with lower internal steam pressure based on the predicted future steam consumption rates. The steam consumption rate may be expressed by any suitable quantity and in any suitable unit. It may be that predicting the future steam consumption rate of each sub-network is also based on the measured steam consumption rate of at least one further sub-network and preferably on the measured steam consumption rate of all sub-networks. Predicting the future steam consumption rate of each sub-network may also be based on any number of other factors, quantities and measurements. These may also be different for each sub-network. It may be that in particular the current steam consumption data of each sub-network is measured.

In this way, steam with higher pressure which is not needed at that high pressure may be provided to steam consumers which also accept steam at a lower pressure. This allows for more efficient use of steam in particular for cases where the demand for steam at higher pressure is temporarily reduced. In addition or alternatively, it may also be that the production rate of steam at the lower pressure is temporarily reduced. When planning a plant, steam network or a set of steam generating sources, fewer steam generation capacity at lower steam pressure values may thus be required which also reduces costs for initial construction and ongoing maintenance.

A preferred embodiment of the method according to the invention is characterized in that the steam network comprises at least one steam buffer tank connected with a respective sub-network for buffering steam at the respective internal steam pressure and that the method comprises d) controlling a steam flow between the at least one steam buffer tank and the respective sub-network based on the predicted future steam consumption rates. The steam flow between the at least one steam buffer tank and the respective sub-network may go in either direction. Thus, the at least one steam buffer tank may supply the respective sub-network with buffered steam. It may also be that the at least one steam buffer tank is supplied with steam from the respective sub-network with steam. By using a steam buffer tank in this way, higher pressure steam may be provided to a sub-network with lower pressure steam from a steam buffer, thereby obviating or lessening the necessity for increased production of steam by the higher pressure external steam generating source.

A further embodiment of the method according to the present invention is characterized in that at least one steam consumer operates as a means for producing a chemical product or intermediate from one or a plurality of reactants, i.e. as a chemical reactor. Preferably, such a steam consumer comprises a material buffer tank for the chemical product or intermediate. The material buffer tank may be used to buffer the product or intermediate produced in excess in case that an excessive amount of steam is temporarily available which temporarily allows for an enhanced production rate. In case of a temporal steam shortage in the sub-network which the steam consumer is connected to the product or intermediate may be supplied to the steam consumer and/or any further plant component arranged downstream of the steam consumer in order to compensate for a reduced production rate due to the steam shortage in the respective sub-network.

A further preferred embodiment of the method according to the invention is characterized in that at least one of the steam consumers is a steam consumer-supplier that supplies steam to a sub-network at its respective internal steam pressure, which supplied sub-network is different from the sub-network supplying the steam consumer-supplier, that a rate of steam supplied to the sub-network by the steam consumer-supplier depends on the steam consumption rate of the steam consumer-supplier and that the method comprises e) controlling the steam consumption rate of the steam consumer-supplier and the rate of steam supplied by the steam consumer-supplier based on the predicted future steam consumption rates. In other words, the steam consumer-supplier is a steam consumer that does not only consume steam but also provides steam back to the steam network and is consequently also a supplier. Generally, the steam provided back to the steam network will have a lower steam pressure than the consumed steam. Consequently, it is preferred that the internal steam pressure of the sub-network supplied by the steam consumer-supplier is lower than the internal steam pressure of the sub-network supplying the steam consumer-supplier. It may be that the rate of steam supplied to the sub-network by the steam consumer-supplier is proportional to the steam consumption rate of the steam consumer-supplier, In other words, there may be a substantially linear relationship between the rate of steam supplied and the rate of steam provided. Thus, such a consumer-supplier may also be used to convert higher pressure steam to lower pressure steam. Preferably, the steam consumer-supplier comprises a distillation column. As well known in the art, distillation columns may be used for a variety of specific applications in chemical plants.

According to a preferred embodiment of the method according to the invention, measuring the steam consumption data of each subnetwork comprises measuring process data of each steam consumer, predicting the future steam consumption rate of each sub-network comprises predicting a future steam consumption rate of each steam consumer based on the measured process data of that steam consumer. In other words, the measurements and predictions are performed on the level of the individual steam consumer rather than the respective sub-network. In any case predicting the future steam consumption rate of each sub-network or each steam-consumer may be further based on any additional data. Preferably, current process data of each steam consumer is measured and predicting a future steam consumption rate of each steam consumer is based on the measured current process data of that steam consumer.

In principle, the process data may comprise any kind of data associated with the steam consumer. According to a preferred embodiment of the method according to the invention, the process data of each steam consumer comprises a steam consumption rate, an energy consumption rate, a plurality of process pressure values, a plurality of process temperature values and/or an ambient quantity of the steam consumer. An ambient quantity of the steam consumer may for example comprise an atmospheric or metereological quantity such as ambient temperature or ambient pressure. All these variables may be indicative of a future steam consumption rate.

According to a further preferred embodiment of the method according to the invention, predicting the future steam consumption rate for each steam consumer is also based on operational settings of that steam consumer. Unlike the process data, which is measured and therefore output by the steam consumer in a certain sense, the operational settings are parameters that are input to the steam consumer and may therefore be controlled by a user or algorithm.

A preferred embodiment of the method according to the invention is characterized in that each sub-network comprises a steam reception valve linking the respective sub-network to its respective connected external steam generating source, the method further comprising controlling a steam reception rate of at least one sub-network via the steam reception valves based on the predicted future steam consumption rates. Thus, even though the amount of steam produced by the steam generating source may be outside of control, what is received by the corresponding sub-network may be controlled by a valve.

A further preferred embodiment of the method according to the invention is characterized in that each sub-network comprises a steam supply valve linking the respective sub-network to the steam consumer supplied by the respective sub-network, the method further comprising controlling a steam consumption rate of at least one steam consumer via the steam supply valves based on the predicted future steam consumption rates. In this way, it is possible to reduce the steam supplied to a specific steam consumer below the predicted consumption rate. This may be useful when it is more economical to have the steam consumption of a specific process below the required level in order to be able to provide sufficient steam to a different steam consumer.

According to a preferred embodiment of the method according to the invention, the method further comprises controlling a steam consumption rate of at least one steam consumer via an operational parameter of the at least one steam consumer based on the predicted future steam consumption rates. Thus, when it is predicted that total steam consumption exceeds the supply, specific steam consumers may be adjusted such that their steam consumption is reduced. Alternatively, in situation in which the predicted total steam consumption remains below the supply, operational settings may be adjusted to increase the steam consumption.

According to a further preferred embodiment of the method according to the invention, predicting the future steam consumption rate for each sub-network, in particular predicting the future steam consumption rate for each steam consumer, comprises predicting an energy consumption rate for each steam consumer. Expressing the steam consumption rate in terms of an energy consumption rate has been found to be particular well suited for calculation. It is further preferred that predicting an energy consumption rate for each steam consumer comprises extrapolating based on past energy consumption rates of that steam consumer.

A preferred embodiment of the method according to the invention is characterized in that predicting the future steam consumption rate for each sub-network, in particular predicting the future steam consumption data for each steam consumer, comprises applying the measured steam consumption rate for each sub-network and preferably the measured process data to a prediction model. In principle, the prediction model may be any kind of model for predicting the future steam consumption rate. Preferably, the prediction model has been obtained from training a statistical model. In this way, historical dependencies of the steam consumption rate may be reflected in the prediction model.

A further preferred embodiment of the method according to the invention is characterized in that the prediction model has been obtained based on a random forest learning method, a neural network, a least absolute shrinkage and selection operator and/or a support vector machine learning method.

The prediction model may also be determined by comparing different kinds of prediction models. According to a preferred embodiment of the method according to the invention, the prediction model has been obtained by training a plurality of candidate prediction models using different training algorithms and selecting a candidate prediction model as obtained prediction model. In particular, selecting the candidate prediction model as obtained prediction model may comprise applying a residual function on each candidate prediction model. In other words, after training the prediction model it is determined which trained model most closely matches the actual consumption rates. The residual function may be applied to a comparison between the candidate prediction models and measured comparison data, which is distinct from the training data.

In principle, the difference in internal steam pressures may be arbitrarily large or small. A preferred embodiment of the method according to the invention is characterized in that the difference in internal steam pressure between at least two sub-networks, preferably between any two sub-networks of the steam network, is at least 500 kPa (5 bar).

A further preferred embodiment of the method according to the invention is characterized in that a maximum steam supply capacity, preferably expressed in power, differs for each external steam generating source. The power thus defines the energy of the provided steam divided by time.

According to a preferred embodiment of the method according to the invention, the steam network is comprised in a plant for a chemical production process. Preferably at least one of the plurality of steam consumers is a process step of the chemical production process.

According to a further aspect of the present invention the object the present invention is based on is solved by a steam network comprising a plurality of sub-networks.

In the steam network according to the present invention each sub-network is connected with a respective external steam generating source that provides the respective sub-network with steam at a respective internal steam pressure, wherein the respective internal steam pressure is different for each sub-network.

The steam network according to the invention further comprises a plurality of steam consumers, each steam consumer supplied with steam by a respective sub-network, and comprises at least one inter-network valve for interconnecting a respective pair of the plurality of sub-networks.

The steam network according to the invention further comprises a control apparatus configured a) for measuring current steam consumption data of each sub-network, b) for predicting a future steam consumption rate of each sub-network based on the measured current steam consumption data of each sub-network and c) for controlling the at least one inter-network valve for providing steam from a sub-network with higher internal steam pressure to a sub-network with lower internal steam pressure based on the predicted future steam consumption rates.

Preferred embodiments, features and advantages of the steam network according to the invention correspond to those of the method according to the invention and vice versa.

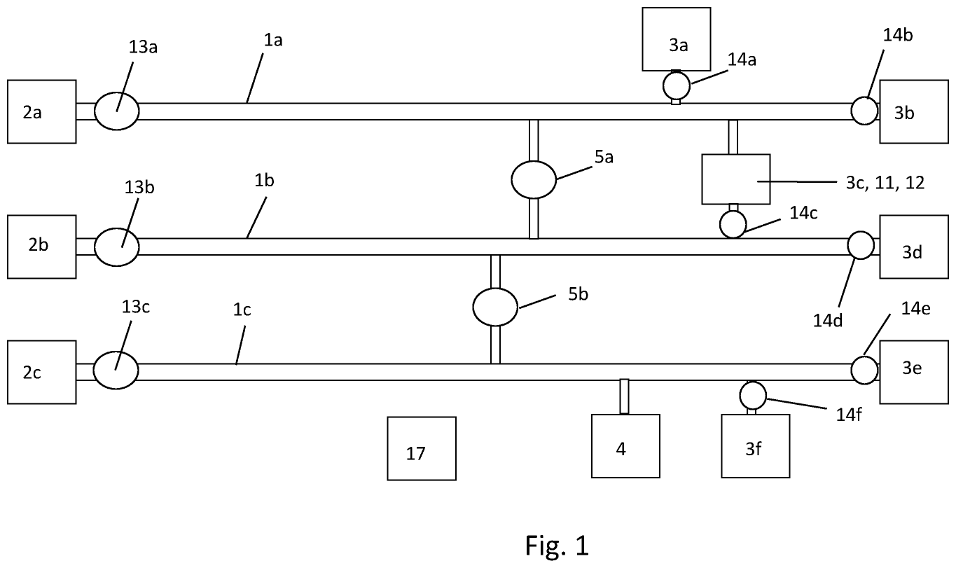

The steam network shown in FIG. 1 is part of a chemical plant for a chemical production process and has three sub-networks 1a, b, c, wherein the first sub-network 1a has an internal steam pressure of 6 bar, wherein the second sub-network 1b has an internal steam pressure of 16 bar and wherein the third sub-network 1c has an internal steam pressure of 31 bar. In order to maintain the respective internal steam pressure, each sub-network 1a-c is supplied with steam at the pressure of the respective internal steam pressure by a respective external steam generating source 2a-c. Each sub-network 1a-c is connected to its respective external steam generating source 2a-c by a respective steam reception valve 13a-c. Though the steam network cannot control the rate at which steam is produced by the external steam generating sources 2a-c, the steam network can control the rate at which steam is received by each sub-network 1a-c from the respective external steam generating source 2a-c through the steam reception valves 13a-c. Control is executed by means of a control apparatus 17 of the steam network.

The steam network also comprises steam consumers 3a-f, wherein the first steam consumer 3a and the second steam consumer 3b are supplied by the first sub-network 1a with steam at 6 bar, wherein the third steam consumer 3c and the fourth steam consumer 3d are supplied by the second sub-network 2b with steam at 16 bar and wherein the fifth steam consumer 3e and the sixth steam consumer 3f are supplied by the third sub-network 1c with steam at 31 bar. The steam network comprises six steam supply valves 14a-f linking the respective sub-network 1a-c to each steam consumer 3a-f.

There is also a steam buffer tank 4 connected to the third sub-network 1c, which steam buffer tank 4 may, controlled by a valve system, which in turn is controlled by the control apparatus 17, buffer steam from the third-subnetwork 1c. In other words, the steam buffer tank 4 may receive steam at 31 bar from the third-subnetwork 1c, thereby increasing its buffer filling level, and, at some later time, provide the previously buffered steam at 31 bar to the third sub-network 1c to the extent corresponding to its filling level. The steam consumption rate as well as other process data 6 of each steam consumer 3a-f including the energy consumption rate, process pressure values and ambient temperatures are continually measured by the control apparatus 17. This measurement of the respective steam consumption rate of the individual steam consumers 3a-f also provides the steam consumption data 10 for each sub-network 1a-c. The third steam consumer 3c is a distillation column 11 and as such presents a steam consumer-supplier 12. That is, the steam consumer 3c does not only consume steam from the second sub-network 1b, but also provides steam to the first sub-network 1a. The reason is that steam used in the distillation column 11 is not fully relaxed or otherwise lost, but instead is only lowered in pressure. Consequently, steam consumed by the distillation column 11 is retrieved at a lower pressure and can be used for other steam consumers at that lower pressure. The rate at which the distillation column 11 provides steam to the first sub-network 1a is linearly proportional to the rate at which the distillation column 11 consumes steam.

The steam network also comprises a first inter-network valve 5a which connects the first sub-network 1a and the second sub-network 1b as well as a second inter-network valve 5b which connects the second sub-network 1b and the third sub-network 1c. The first and second inter-network valves 5a, b are pressure reducing valves. The first inter-network valve 5a permits supplying steam to the first sub-network 1a at 6 bar from the second sub-network 1b at 16 bar The second inter-network valve 5b permits supplying steam to the second sub-network 1b at 16 bar from the third sub-network 1c at 31 bar. Thereby, higher demand for steam at one of the sub-networks 1a-c with lower internal steam pressure may be met with steam from a sub-network 1a-c with a higher internal steam pressure. It is also possible to install a further interconnect valve (not shown) which connects the first sub-network 1a and the third sub-network 1c and thus skips the second sub-network 1b requiring a stronger pressure reduction from—in the present case −31 bar in the third sub-network 1c to 6 bar in the first sub-network 1a.

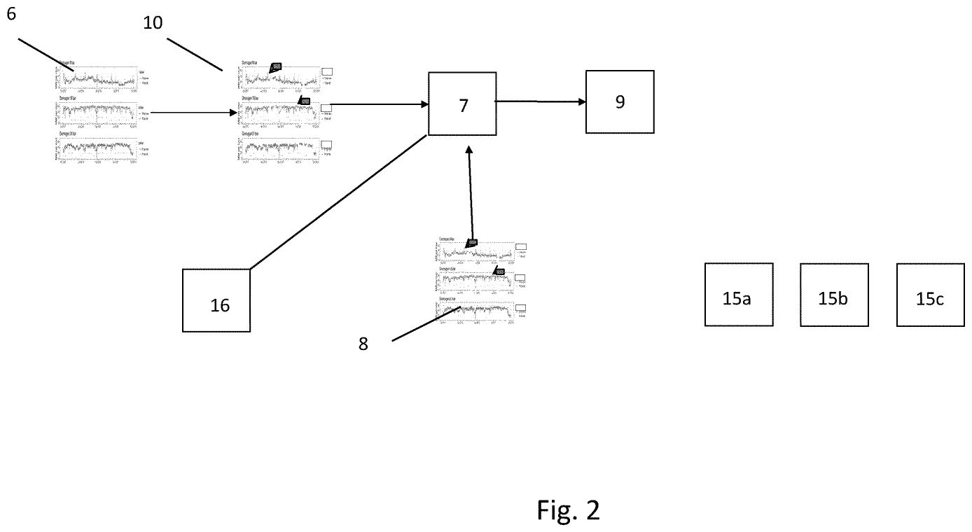

As shown in FIG. 2, from the measured process data 6 of each steam consumer 3a-f, steam consumption data 10 of each sub-network 1a-c over an observation time is obtained, both of which in turn are applied to a prediction model 7. This prediction model 7 runs on a computer system 16 and has been obtained based on a neural network that was trained with longer-term historical process data 8 of each steam consumer 3a-f. It was selected from the three candidate prediction models 15a-c as being the most accurate as measured by a residual function applied to the predictions generated by each candidate prediction model 15a-c. In addition, current operational settings of each steam consumer 3a-f, which correspond to values input by the respective operator of the steam consumer 3a-f, are also applied to the prediction model 7.

This prediction model 7 provides a predicted future steam consumption rate for each steam consumer 3a-f, from which in turn a future steam consumption rate 9 of each sub-network 1a-c is calculated. The prediction model 7 is able to provide this prediction because the neural network is able to reveal interdepend-encies between the process data 6 of the steam consumers 3a-f and the following steam consumption rates. For example, several chemical production processes follow certain cycles, in which a peak in steam consumption by a certain steam consumer 3a-f is followed by a peak in steam consumption rate by a specific different steam consumer 3a-f after a certain time.

Now based on the predicted future steam consumption rate 9 of each sub-network 1a-c, the inter-network valves 5a, b are controlled by the control apparatus 17 in order to compensate for predicted peaks in demand for one sub-network 1a-c. For example, when it is predicted that there is demand peak at the first sub-network 1a, caused by a predicted peak in steam consumption by the first steam consumer 3a, higher pressure steam from the second sub-network 1b may be provided to the first sub-network 1a by means of the first inter-network valve 5a. When, during the time of the predicted demand peak at the first sub-network 1a, the predicted steam consumption rate at the second sub-network 1b is below the steam production capacity of the second steam generating source 2b, then the predicted peak in steam consumption may be met without needing more steam from the first steam generating source 2a. Likewise, to meet a predicted demand peak at the second sub-network 1b, higher pressure steam from the third sub-network 1c may be provided by means of the second inter-network valve 5b.

Beside the control of the inter-network valves 5a, b, additional measures are also taken to meet any predicted peaks in demand by the control apparatus 17. The steam buffer tank 4 is filled with steam at a time of low predicted steam consumption of the third sub-network 1c. At times in which either a high steam consumption rate is predicted for the third sub-network 1c or a high steam consumption rate for the first sub-network 1a or the second sub-network 1b is predicted, but which is to be provided by the third sub-network 1c and the inter-network valves 5a, b, the steam buffer tank 4 provides previously buffered steam to the third sub-network 1c. Further, the steam consumption rate of the distillation column 11 is controlled, thereby also controlling the rate at which it supplies steam to the first sub-network 1a. The steam reception rate of each sub-network 1a-c is controlled by means of the steam reception valves 13a-c. Likewise, the steam consumption rate of each steam consumer 3a-f is controlled, either through controlling the corresponding steam supply valve 14a-f or through controlling the operational settings of the steam consumer 3a-f. A combination of the cited measures is used to balance supply and demand for each sub-network 1a-c.

A described above the steam network cannot control the rate at which steam is produced by the external steam generating sources 2a-c. Rather, the rate at which steam is received by each sub-network 1a-c from the respective external steam generating source 2a-c is controlled by the steam network through the steam reception valves 13a-c.

However, in a further development of the steam network of FIG. 1 (not shown, but described e.g. in U.S. 2004/0093124 A1) also the steam generating process is optimized by implementing an optimal dynamic allocation of fuel feed demands for the steam generators 2a-c by means of a model-based predictive controller. Here, the predictive controller suitably senses the energy requirements of the steam generators 2a-c, and provides a predicted total load energy demand to a real time optimizer (RTO) that divides the total load energy demand according to a predicted target allocation into individual allocated energy demands for the individual steam generators 2a-c.

Although the present invention may be further improved by implementing the above described optimization of the allocation of energy demands for the steam generators 2a-c the steam network according to the present invention focuses on the steam consumption. This is done by sensing multiple consumption rates and predicting future steam consumption rate for each steam consumer 3a-f, from which in turn a future steam consumption rate 9 of each sub-network 1a-c is calculated. This makes it possible to shift consumption between the sub-networks 1a-c by means of the inter-network valves 5a, b.

1. A method for controlling a steam network, wherein the steam network comprises a plurality of sub-networks, wherein each sub-network is connected with a respective external steam generating source that provides the respective sub-network with steam at a respective internal steam pressure, wherein the respective internal steam pressure is different for each sub-network, the steam network further comprising a plurality of steam consumers, each steam consumer supplied with steam by a respective sub-network, the steam network further comprising at least one inter-network valve for interconnecting a respective pair of the plurality of sub-networks, the method comprising
a) measuring steam consumption data of each sub-network,
b) predicting a future steam consumption rate of each sub-network based on the measured steam consumption data of each sub-network and
c) controlling the at least one inter-network valve for providing steam from a sub-network with higher internal steam pressure to a sub-network with lower internal steam pressure based on the predicted future steam consumption rates,
wherein in the steam network the rate at which steam is produced by the external steam generating sources is not controlled.

2. The method according to claim 1, wherein the steam network comprises at least one steam buffer tank connected with a respective sub-network for buffering steam at the respective internal steam pressure and that the method comprises d) controlling a steam flow between the at least one steam buffer tank and the respective sub-network based on the predicted future steam consumption rates.

3. The method according to claim 1, wherein at least one of the steam consumers is a steam consumer-supplier that supplies steam to a sub-network at its respective internal steam pressure, which supplied sub-network is different from the sub-network supplying the steam consumer-supplier, that a rate of steam supplied to the sub-network by the steam consumer-supplier depends on the steam consumption rate of the steam consumer-supplier and that the method comprises e) controlling the steam consumption rate of the steam consumer-supplier and the rate of steam supplied by the steam consumer-supplier based on the predicted future steam consumption rates.

4. The method according to claim 1, wherein measuring the steam consumption data of each sub-network comprises measuring process data of each steam consumer and that predicting the future steam consumption rate of each sub-network comprises predicting a future steam consumption rate of each steam consumer based on the measured process data of that steam consumer.

5. The method according to claim 4, wherein the process data of each steam consumer comprises a steam consumption rate, an energy consumption rate, a plurality of process pressure values, a plurality of process temperature values and/or an ambient quantity of the steam consumer.

6. The method according to claim 4, wherein predicting the future steam consumption rate for each steam consumer is also based on operational settings of that steam consumer.

7. The method according to claim 1, wherein each sub-network comprises a steam reception valve linking the respective sub-network to its respective connected external steam generating source, the method further comprising controlling a steam reception rate of at least one sub-network via the steam reception valves based on the predicted future steam consumption rates.

8. The method according to claim 1, wherein each sub-network comprises a steam supply valve linking the respective sub-network to the steam consumer supplied by the respective sub-network, the method further comprising controlling a steam consumption rate of at least one steam consumer via the steam supply valves based on the predicted future steam consumption rates.

9. The method according to claim 1, wherein the method further comprises controlling a steam consumption rate of at least one steam consumer via operational settings of the at least one steam consumer based on the predicted future steam consumption rates.

10. The method according to claim 1, wherein predicting the future steam consumption rate for each sub-network comprises predicting an energy consumption rate for each steam consumer.

11. The method according to claim 1, wherein predicting the future steam consumption rate for each sub-network comprises applying the measured steam consumption data for each sub-network to a prediction model.

12. The method according to claim 11, wherein the prediction model has been obtained by training a plurality of candidate prediction models using different training algorithms and selecting a candidate prediction model as obtained prediction model by applying a residual function on each candidate prediction model.

13. The method according to claim 1, wherein a maximum steam supply capacity, differs for each external steam generating source.

14. The method according to claim 1, wherein the steam network is comprised in a plant for a chemical production process.

15. A steam network comprising a plurality of sub-networks, wherein each sub-network is connected with a respective external steam generating source that provides the respective sub-network with steam at a respective internal steam pressure, wherein the respective internal steam pressure is different for each sub-network, the steam network further comprising a plurality of steam consumers, each steam consumer supplied with steam by a respective sub-network, the steam network further comprising at least one inter-network valve for interconnecting a respective pair of the plurality of sub-networks, the steam network further comprising a control apparatus configured a) for measuring steam consumption data of each sub-network, b) for predicting a future steam consumption rate of each sub-network based on the measured steam consumption data of each sub-network for controlling the at least one inter-network valve for providing steam from a sub-network with higher internal steam pressure to a sub-network with lower internal steam pressure based on the predicted future steam consumption rates, wherein the rate at which steam is produced by the external steam generating sources is not controlled by the control apparatus.
